(19) United States
(12) Patent Application Publication
(10) Pub. No.: US 2009/0294014 A1
(43) Pub. Date: Dec. 3, 2009

(54) HOT GLUE APPLICATION DEVICE

(75) Inventor: Markus SENNRICH, Rombach (CH)

Correspondence Address: BROWDY AND NEIMARK, P.L.L.C.;624 NINTH STREET, NW, SUITE 300, WASHINGTON, DC, 20001-5303, US

(73) Assignee: Robatech AG, Muri (CH)

(21) Appl. No.: 12/174,473

(22) Filed: Jul. 16, 2008

(30) Foreign Application Priority Data
Jun. 3, 2008 (DE) 20 2008 007 386.3

(51) Int. Cl. B29C 65/52

(52) U.S. Cl. 156/60; 156/381

(57) ABSTRACT

The invention relates to a device (1) for applying heated adhesive and/or hot glue having at least one application head (2) having at least one nozzle (3) and a controller for the delivery of the heated adhesive and/or hot glue through the nozzle (3), the application head (2) being sheathed by a housing (4) and the housing (4) exposing an opening (5) for the nozzle (3) in such a way, that the nozzle (3) is enclosed on at least two diametrically opposite sides by at least two webs (6a, 6b).

The invention relates to a device for the controlled delivery of a viscous material through a nozzle, for applying or spraying on adhesive, in particular hot glue, for example. The present application claims the priority of the German utility model DE-U-20 2008 007 386.3 filed on 3 Jun. 2008.

Such devices are typically conceived for an automatically controlled, machine process, which is subject to a high processing speed. The devices must accordingly fulfill high requirements in regard to precision, functionality, durability, and freedom from maintenance, but also ease of maintenance.

Furthermore, such devices are typically equipped with a—pneumatic, for example—controller, which on one hand controls the quantity of the adhesive and/or hot glue delivered through the nozzle. On the other hand, however, it controls whether a continuous bead, and/or a continuous strand or an interrupted strand is to be applied or only spots are to be applied. The composition of the adhesive and/or hot glue, but also the controller are more preferably designed in such a way that, for example, upon punctual application the adhesive and/or hot glue spots are always equally large and do not form threads.

The applicant has put two series of application heads on the market under the names SX and AX, which already fulfill these stated requirements to a high degree. (See Robatech brochures “SX-Serie Spritzköpfe für Schmelzkleber [SX series spray heads for hot melt adhesives]”, printing April 2003 and “AX 100 Serie Spritzköpfe für Schmelzkleber [AX 100 series spray heads for hot melt adhesives]”, printing June 2004.)

For specific applications and under specific conditions, however, it has been shown that the requirements described above could desirably be fulfilled to an even greater extent.

In particular, it has proven to be disadvantageous that the ease of maintenance of the application heads has suffered because they heat up to approximately 180° C. Furthermore, it has proven that the nozzle has not provided constant results if it was subjected to a temperature-changing air draft, for example. Mechanical damage could also often occur to the nozzle if the product to be glued was warped or had irregularities, for example.

The solution was found in that the application heads have been provided according to the invention with a sheath which insulates and protects them. This sheath is simultaneously shaped according to the invention in such a way that it has at least two diametrically opposite webs enclosing the nozzle.

The webs or also a circular protrusion enclosing the nozzle may project beyond the nozzle or lie at the same height. Preferably, however, they project beyond the nozzle at a distance and are shaped as runners whose longitudinal direction corresponds to the direction in which the product to be glued and/or the application heads are moved past one another. The runners are preferably designed as ramps, i.e., rising and falling again in profile, to avoid hooking on the product sliding past.

In a preferred embodiment of the device according to the invention for applying heated adhesive and/or hot glue, the webs and/or the runners are adjustable in their height in relation to the nozzle. However, it may be desirable depending on the type of application or the type of material to be glued to situate the nozzle and the webs at the same height, or to have the nozzle project beyond the webs or vice versa to have the webs project beyond the nozzle in such a way that the glued product may contact the webs, but no longer the nozzle. This adjustability may be implemented easily in that the housing is provided with webs of different heights and they are mounted as needed. This selection of appropriately tall webs may be supported further by a selection of nozzles of different heights. This adjustability of the vertical distance between the nozzle and the webs may also be implemented, however, in that the fastening of the housing to the application head is adjustable. This may be performed using an oblong hole, for example. However, embodiments in which the webs themselves are arranged so that they are displaceable and fixable within a frame, are also conceivable.

The housing enclosing the application head according to the invention may comprise plastic. For example, halves molded in the injection-molding method from PEEK (polyetheretherketone), PEI (polyetherimide), PES (polyethersulfone), PSU (polysulfone), or PPS (polyphenylene sulfide) or also fiberglass-reinforced variants have proven to be advantageous and wear resistant, and may be assembled using screws, for example. The applicant has had good experience with a 40% fiberglass-reinforced polyphenylene sulfide resin from Chevron Phillips Chemical Company LP of The Woodlands, Tex. named Ryton® R-4.

Furthermore, the housing may have slots according to the invention, which are used on one hand for better handling ability and on the other hand provide a surface enlargement, which ensures better heat dissipation to the environment.

According to the invention, the housing sheathes between 75 and 95% of the lateral surface of the application head. These are preferably complete sheaths which only still leave the terminals and the nozzle exposed.

The housing has a slider, which, preferably provided with a catch or click closure, is manually displaceable in such a way that it releases an opening which allows a replacement or adjustment of the nozzle.

The nozzle itself preferably has an opening diameter of 0.5 to 5.0 mm, depending on the viscosity of the adhesive and/or hot glue used. However, the applied pressure is also decisive, which may be up to 200 bar. To guarantee a continuous flow of the adhesive and/or hot glue through the nozzle, a filter is preferably integrated in the device. Furthermore, the nozzle optionally has a heatable nozzle extension or a heatable nozzle attachment.

The device according to the invention preferably has a controller which causes a continuous strand or an interrupted strand or only spots to be applied. This controller may operate pneumatically, for example. The combination of applied pressure, the nozzle composition, the viscosity of the adhesive and/or hot glue, and the controller are the decisive influencing factors on the application behavior of the device. Ideally, it is as constant as possible, uniform, and does not form threads. To influence thread formation, but also the temperature behavior of the nozzle itself, an air nozzle may be provided which blows against the nozzle.

As already described, continuous or interrupted strands are also only spots may be applied. However, spraying may also be performed, in greatly varying forms, for example, in the form of a spiral or whorl.

Thermoplastics, PUR adhesives, sealants, or butyl come into consideration as adhesives and/or hot glue. They are heated to a temperature of up to 200° C., i.e., preferably supplied to the device already heated, but the device itself preferably also has a heatable supply hose.

The device according to the invention is preferably a modular component of a device system. Each individual device then has an identical fastening, for example, in the form of a shell closable using screws. This fastening may in turn be attached to a shared fastening device of the device system. This may be a rod, for example, which is enclosed by the shell. In this way, multiple individual devices and/or application heads may be arrayed arbitrarily on the rod and shifted depending on how many parallel strands are to be applied and at which intervals to one another. The shell is in turn preferably openable, so that an already fastened application head does not have to be pulled off of the rod to attach an additional application head. Easy replaceability and ability to place the individual devices and/or the application heads arbitrarily spaced are thus to be ensured according to the invention in any case. The individual parts of the device according to the invention and their fastenings are kept identical or even standardized for this purpose.

The following advantages are achieved in relation to known devices by a device according to the invention for applying adhesive and/or hot glue:
The application heads, which are heated to approximately 180° C., are no longer free, by which the danger of burning oneself is reduced.
Replacement and maintenance work may be completed more rapidly, because one no longer has to wait until the application heads have cooled.
The application head is no longer so susceptible to changing external temperatures. The nozzle thus maintains its setpoint temperature better.
The application head dissipates less heat to the environment. The energy efficiency thus improves.
The cooling of the application head and its connections from the operating temperature to room temperature, but also its heating from room temperature to the operating temperature are “cushioned”, so that less material fatigue occurs and the attachment connections are maintained better.
The electrical parts are electrically insulated better.
The nozzle is protected from air drafts by the enclosure using at least two webs. Cooling of the nozzle is thus avoided, which may result in an unclean and/or uneven and interrupted application.

Further implementations of the invention are specified in the figures and in the dependent claims.

The list of reference numerals is part of the disclosure.

The invention is explained symbolically and for exemplary purposes in greater detail on the basis of figures.

The figures are described coherently and comprehensively. Identical reference numerals indicate identical components, reference numerals having different indices indicate functionally-identical or similar components.

In the figures

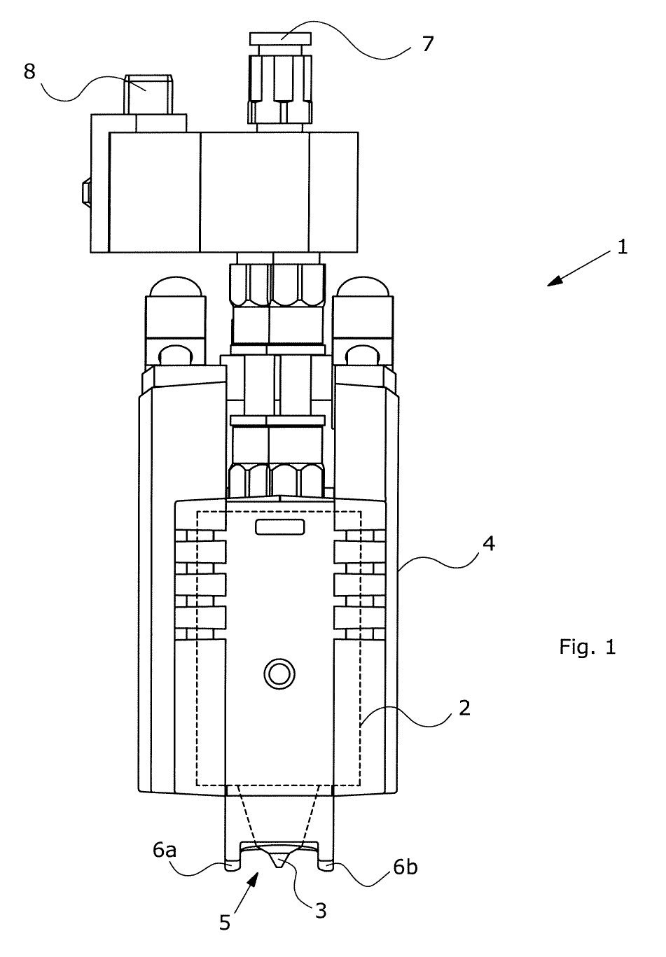

FIG. 1—shows the frontal view of a device according to the invention for applying heated adhesive and/or hot glue;

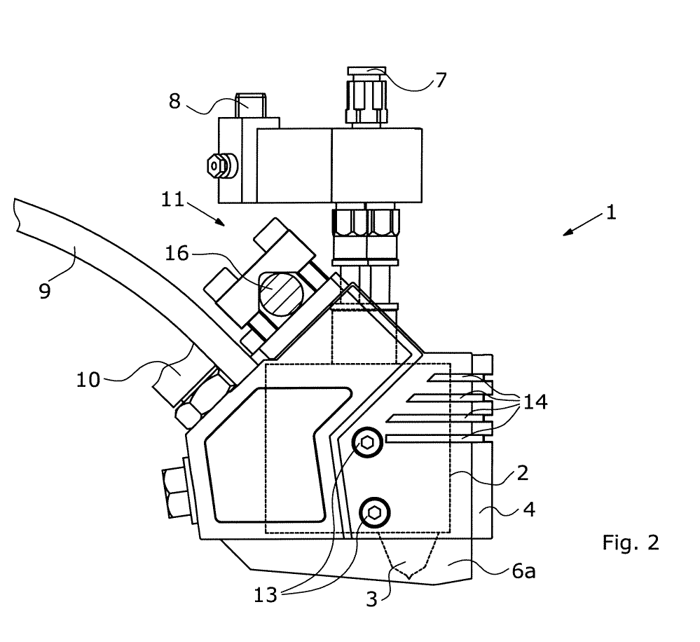

FIG. 2—shows a side view of the device according to the invention from FIG. 1, and

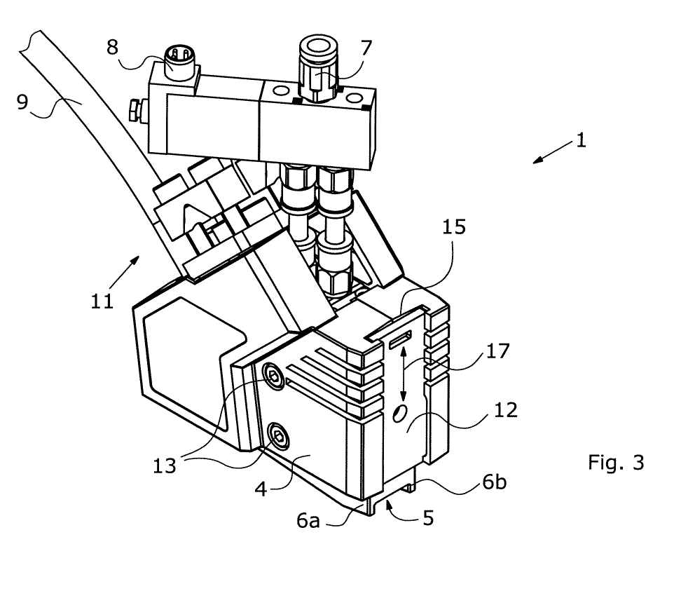

FIG. 3—shows a perspective view of the device according to the invention from the two preceding figures.

FIG. 1 shows the frontal view of a device 1 according to the invention. A housing 4 according to the invention sheathes an application head 2 shown by dashed lines, on which a nozzle 3 is arranged. The housing 4 sheathes the application head 4 in such a way that an opening 5 for the nozzle 3 remains exposed. The housing 4 simultaneously forms two webs 6a and 6b located laterally from the nozzle 3. Furthermore, a connection 7 for an air supply for a pneumatic controller of the nozzle 3 is shown. A plug 8 or a cable opening is used for receiving and relaying electrical control pulses.

FIG. 2 shows the device 1 according to the invention from FIG. 1 in a side view. It may be seen that the housing 4 is screwed onto the application head 2 using screws 13. The housing 4 has slots 14 which are used for handling ability, but also better temperature exchange. An adhesive and/or hot glue supply 10 feeds the device 1 with the required adhesive and/or hot glue and may optionally be designed as heatable. The device 1 is supplied with power via an electric cable 9. Furthermore, the device 1 has a fastening 11 in the form of a shell which may be screwed together, which encloses a rod 16 shown in section.

FIG. 3 shows a perspective view of the device 1 according to the invention from FIGS. 1 and 2. It is obvious in this view that the housing 4 comprises two halves and forms a further opening 15 in addition to the opening 5 for the nozzle 3 (see FIG. 1). A slider 12 having a catch device is arranged so it is displaceable in this opening 15, as indicated by a double arrow 17. When it is slid away, the opening 15 exposes the application head 2 and the nozzle 3 for maintenance, adjustment, or replacement.

### LIST OF REFERENCE NUMERALS

1—device
2—application head
3—nozzle
4—housing
5—opening
6a, 6b—web
7—connection for air supply
8—plug for current controller
9—electric cable
10—adhesive and/or hot glue supply
11—fastening
12—slider
13—fastening screw
14—slot
15—opening
16—rod
17—double arrow (movement direction of slider 12)

1. A device (1) for applying heated adhesive and/or hot glue having at least one application head (2) having at least one nozzle (3) and a controller for the delivery of the heated adhesive and/or hot glue through the nozzle (3), wherein the application head (2) is sheathed by a housing (4) and the housing (4) exposes an opening (5) for the nozzle (3) in such a way that the nozzle (3) is enclosed on at least two diametrically opposite sides by at least two webs (6a, 6b).

2. The device (1) according to claim 1, wherein the housing (4) comprises plastic, preferably PEEK, PEI, PES, PSU, or PPS.

3. The device (1) according to claim 1, wherein the housing (4) comprises two halves which are closable using fastening screws (13).

4. The device (1) according to claim 1, wherein the webs (6a, 6b) project beyond the nozzle (3).

5. The device (1) according to claim 1, wherein the housing (4) has slots (14).

6. The device (1) according to claim 1, wherein the housing (4) has an opening (15) for a slider (12), which exposes the access to the nozzle (3), which is replaceable.

7. The device (1) according to claim 1, wherein the nozzle (3) has an opening diameter from 0.5 mm to 5 mm, preferably 2 mm.

8. The device (1) according to claim 1, wherein an air nozzle is arranged, which may blow against the nozzle (3).

9. The device (1) according to claim 1, which is pneumatically controllable via a compressed air supply (7) having a pressure of 0 up to 250 bar, preferably up to 200 bar.

10. The device (1) according to claim 1, wherein an adhesive and/or hot glue supply (10) is arranged, which is heatable.

11. The device (1) according to claim 1, which is a modular component of a device system and is selectively and at arbitrary intervals arrangeable on a shared fastening device (16) using an identical fastening (11).

12. The device (1) according to claim 1, further comprising an integrated filter, using which the heated adhesive and/or hot glue may be filtered before the exit from the nozzle (3).

13. A method of applying or spraying on heated adhesive and/or hot glue using a device (1) according to claim 1.

14. An application head (2) in a device (1) for applying heated adhesive and/or hot glue, having a nozzle (3) and a controller for the delivery of the heated adhesive and/or hot glue through the nozzle (3), wherein the application head (2) is sheathed using a housing (4) and the housing (4) exposes an opening (5) for the nozzle (3) in such a way that the nozzle (3) is enclosed on at least two diametrically opposite sides by at least two webs (6a, 6b).
